(19) United States
(12) Patent Application Publication
(10) Pub. No.: US 2008/0245461 A1
(43) Pub. Date: Oct. 9, 2008

(54) COVER STOCK CUTTER AND SPLICING APPARATUS FOR WALLBOARD MANUFACTURE AND METHODS OF USING THE SAME

(75) Inventor: Joseph A. Lamkin, Westminster, CA (US)

Correspondence Address: PATENT GROUP GA030-43;GEORGIA-PACIFIC LLC, 133 PEACHTREE STREET, N.E., ATLANTA, GA, 30303-1847, US

(73) Assignee: Georgia-Pacific Gypsum LLC, Atlanta, GA (US)

(21) Appl. No.: 11/697,321

(22) Filed: Apr. 6, 2007

(51) Int. Cl. B32B 13/08

(52) U.S. Cl. 156/39; 156/346

(57) ABSTRACT

A cover stock supply system for continuously feeding cover stock to a wallboard production line includes: a plurality of cover stock cradles for receiving rolls of cover stock; a splicing table; a cover stock cutter disposed between the cover stock cradles and the splicing table. The cover stock cutter has a positioning loop around a cover stock feed path and a cutting cable attached to the positioning loop. Cutter is configured and adapted to rotatably deploy the cutting cable from the drawn position on a first side of the cover stock feed path to a re-set position on a second side of the cover stock feed path upon motion thereof around the cover stock feed path.

### BACKGROUND

The present disclosure relates generally to the manufacture of wallboard and more specifically to a cover stock cutter and splicing apparatus.

Generally, wallboard is conventionally produced by sandwiching a core of aqueous “slurry” or paste of calcined gypsum and other materials between two continuous sheets of cover stock or board (typically paper or glass mat). See generally, U.S. Pat. No. 5,718,797 to Phillips et al. Various types of cover paper and glass mat are known in the art, and all such types can be used for this purpose. After the gypsum slurry has set (i.e., reacted with the water from the aqueous slurry) for a period of time, the resulting long board is cut into manageable sections. These sections are then further dried and the finished product becomes a strong, rigid, fire-resistant building material, which can then be cut into various sizes as desired.

Commercial manufacture of gypsum wallboard is often accomplished by processes that are capable of operation under continuous high speed conditions. In such applications, the aqueous slurry of calcined gypsum and other ingredients are continuously deposited onto a first continuously supplied, moving web of cover stock. Shortly thereafter, a second continuously supplied, moving web of cover material is then directed over the top of the slurry, such that the slurry is then sandwiched between two sheets of cover material. This resulting product continues to move onward from this “wetend” location (where the paper and slurry are combined) at high speeds.

Because continuous high speed operation without interruption is desirable in the manufacturing process, “on the fly” splicing of a new roll of cover material to the end or near the end of a depleted roll is common practice. It is thus typical to have at least a pair of adjacent spindles for mounting two large rolls of cover paper for both the first and the second continuously supplied, moving webs of cover material. A machine or operator monitors a roll of cover paper in use and when a roll of cover material is close to expiring, a new roll is spliced to the expiring roll. See U.S. Pat. No. 6,868,883 to Benedetti.

Various details as to paperboard manufacture are seen in the following patents and published applications: U.S. Pat. No. 7,151,553 to Fox, Jr., et al.; U.S. Pat. No. 6,475,313 to Peterson et al.; U.S. Pat. No. 6,403,688 to Luongo; U.S. Pat. No. 6,319,312, also to Luongo; and U.S. patent application Ser. No. 11/017,510 (Publication No. 2005/0097856) of Fox et al. Commercially available systems include cutting cables that may be rotated around a sheet of cover stock; however, available systems require that the cutting cable be handled manually between cutting operations. One such cover stock feed system was provided to Georgia-Pacific Gypsum LLC by Ancaster Conveying Systems Ltd. (Ontario, Canada) which included a bottom tension system (SN13844), a bottom automated splicing table (SN 13842), a bottom roll cradle system (SN13840), a top automated splicing table (SN13843), a top tension system (SN13845) and a top roll cradle system (SN13841).

In conventional manual splicing, if the tail is inadvertently fed forward (which happens despite the exercise of a high level of skill), the production equipment may be fouled and/or breaks in the cover material may occur, requiring that the line be shut down.

Accordingly, a continual need exists for a more reliable cutting and splicing of cover stock material apparatus.

### BRIEF SUMMARY

In one embodiment, a cutter for wallboard cover stock comprises a support frame having a cover stock feed path therethrough; a positioning loop around the cover stock feed path mounted on the support frame; a cutting cable attached to the positioning loop; a biasing and tensioning mechanism for biasing the cutting cable to a drawn position and maintaining tension on the cable; and a releasable cable lock for securing the cable in the re-set position and releasing the cable therefrom for transfer to the drawn position. The positioning loop is configured and adapted to rotatably deploy the cutting cable from the drawn position on a first side of the cover stock feed path to a re-set position on a second side of the cover stock feed path upon motion thereof around the cover stock feed path. The biasing and tensioning mechanism is adapted so as to be operable to (i) draw the cutting cable from the re-set position to the drawn position through the cover stock feed path thereby cutting cover stock disposed in the feed path; and (ii) maintain tension on the cutting cable as it is moved from the drawn position to the re-set position, thereby retracting any slack portions of the cable to a sequestered position away from the cover stock feed path.

The above described and other features are exemplified by the following Figures and detailed description.

### BRIEF DESCRIPTION OF THE DRAWINGS

Referring to the exemplary drawings wherein like elements are numbered alike in the several Figures:

FIG. 1 is a schematic diagram illustrating generally an embodiment of a cover stock supply system;

FIG. 2 is a partial perspective side view of the cover stock supply system of FIG. 1 illustrating the cover stock cutting system and splicing table;

FIG. 3 is a perspective view of cover stock cutter of the supply system of FIG. 2;

FIG. 4 is a front perspective view of the cover stock cutter of FIG. 2;

FIG. 5 is an end perspective view of the cover stock cutter of FIG. 2;

FIGS. 6A-6D are schematic diagrams illustrating operation of the cutter of FIGS. 2, 3, 4 and 5; and

FIG. 7 is a schematic diagram illustrating inclination of the cover stock feed path through the cutter and the cutting plane as a cutting cable is drawn through a web of cover stock.

### DETAILED DESCRIPTION

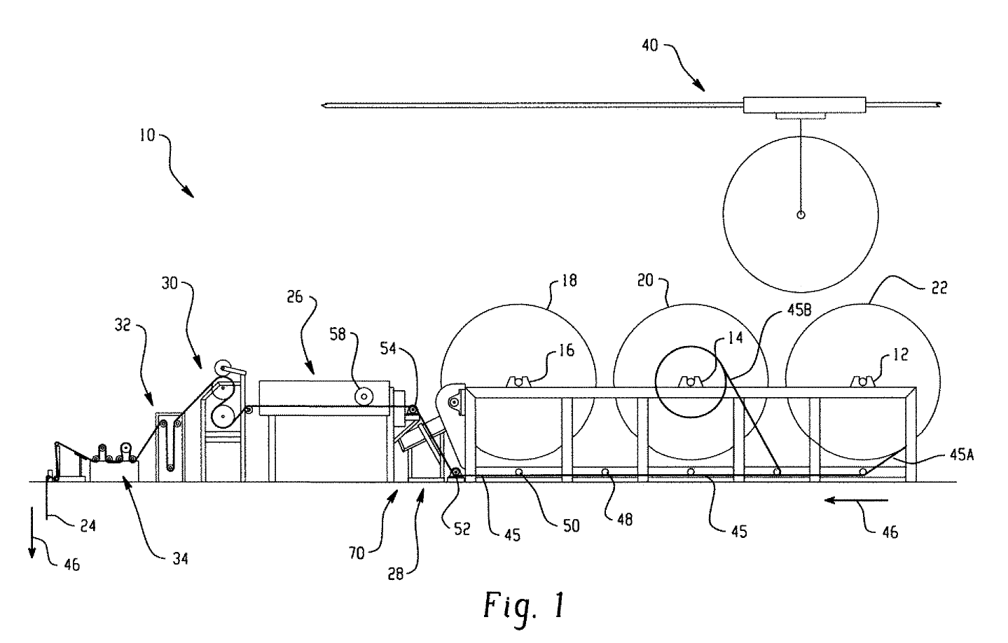

There is illustrated schematically in FIG. 1 a cover stock supply system 10 used to continuously provide a web of cover stock to a wallboard manufacturing line of the class described in U.S. Pat. No. 6,868,883 to Benedetti and U.S. Pat. No. 5,718,797 to Phillips et al., the disclosures of which are incorporated herein by reference. The term “Cover stock” refers generically to backing material used as the front and/or back of wallboard. Suitable cover stock materials include, but are not limited to, paper and glass mat.

System 10 includes a plurality of cradles 12, 14, 16 for receiving rolls 18, 20, 22 of cover stock for feeding to a wallboard manufacturing line at 24, as well as a splicing table 26 and a cutter 28. The line is also provided with pull rolls at 30, a dancer roll at 32 and a tensioning/web conditioning system at 34. Optionally provided is a re-supply rail 40 for providing additional rolls of cover stock to cradles 12, 14 and 16.

System 10 continuously supplies a web 45 of material to the wallboard manufacturing line from rolls 18, 20 and 22 generally in direction 46 fed over a plurality of rollers such as rollers 48, 50, 52, 54 and so forth. Each roll of cover stock is sequentially fed forward to the wallboard manufacturing line after the preceding roll has been exhausted. For example, at start-up, a web 45A from roll 22 may be fed forward to the production line past a cutter at 28, splicing table 26 and through pull rolls at 30, the dancer roll at 32 and the web tensioner at 34 and then fed to the wallboard production unit. As roll 22 is exhausted, web 45B from roll 20 is fed forward in direction 46 and spliced to the web from roll 22 at splicing table 26, whereupon the tail from depleted roll 22 must be severed. While the dancer roll at 32 accumulates enough cover stock to supply the wallboard manufacturing line with material for a short time during roll changeover, a cutting and splicing operation must be accomplished quickly to avoid a line shut-down.

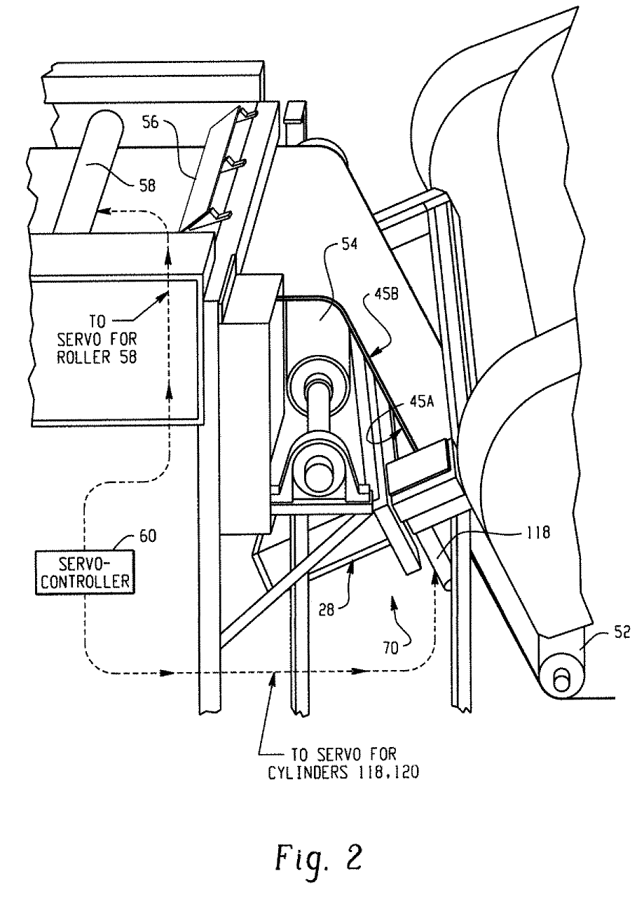

FIG. 2 is a side view illustrating a changeover operation. Web 45A is being continuously supplied to the wallboard production line while web 45B is prepared for splicing with a piece of double-sided tape 56 to secure it to web 45A. When roll 22 is nearly depleted, the web 45A is briefly stopped at the splicing table while material accumulated at dancer roll 30 supplies the production line. Web 45B is then spliced to web 45A optionally utilizing a pneumatically actuated splicing roller 58. Web 45A is quickly severed to avoid the tail from being dragged forward by web 45B of the spliced web, which in turn can prevent production problems in the wallboard production line.

In one embodiment, the tail of the depleted roll is severed within about a second of splicing web 45B to web 45A. To this end, there is provided a pneumatically activated cutter 28 at position 70 the action of which can be coordinated with the splicing operation of splicing roller 58 by way of a servo-controller 60.

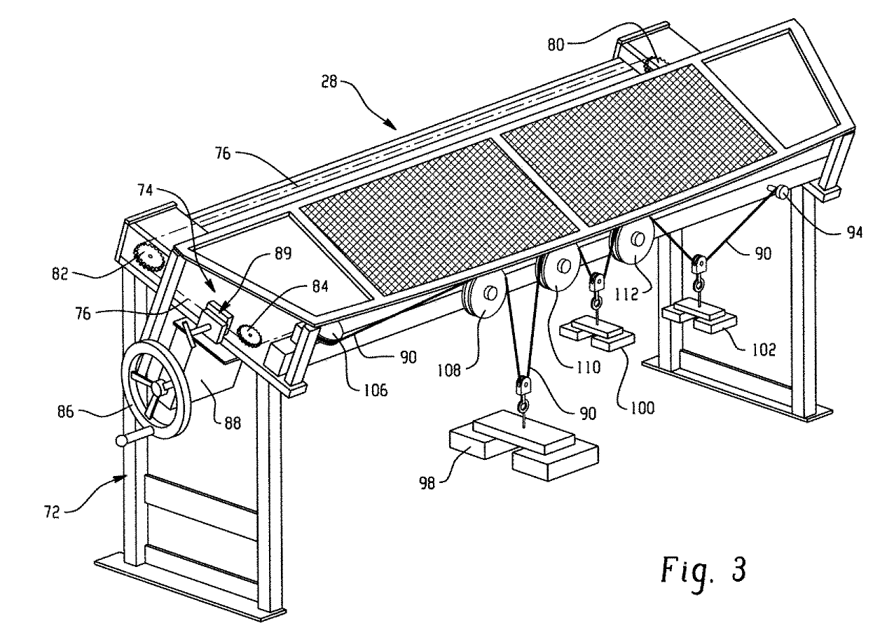

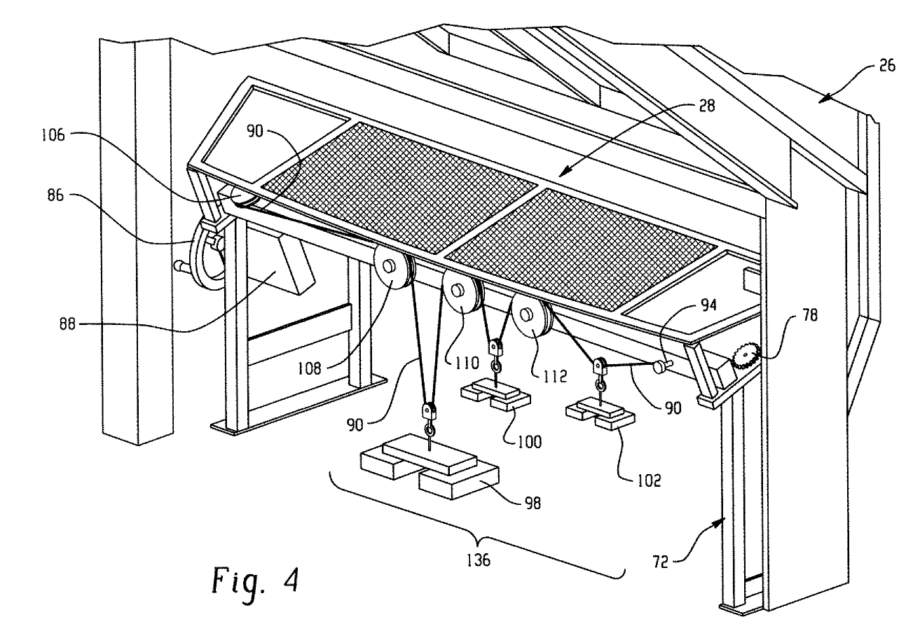

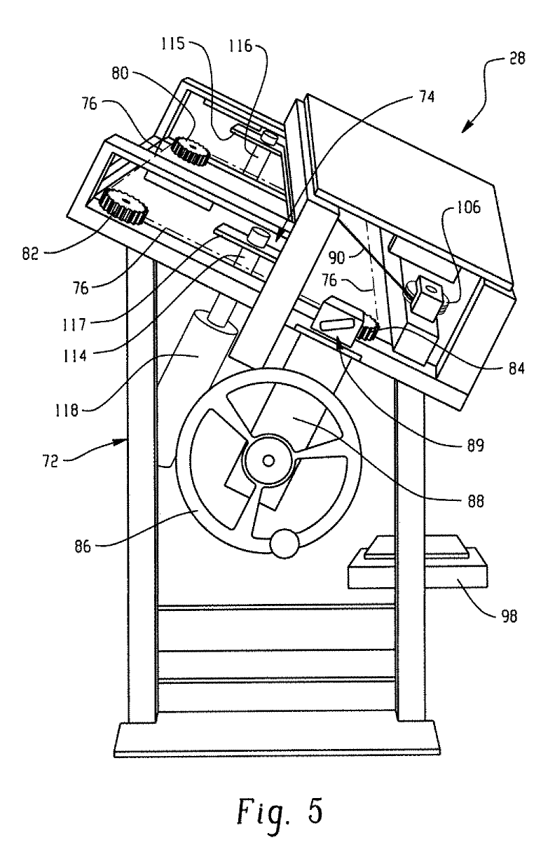

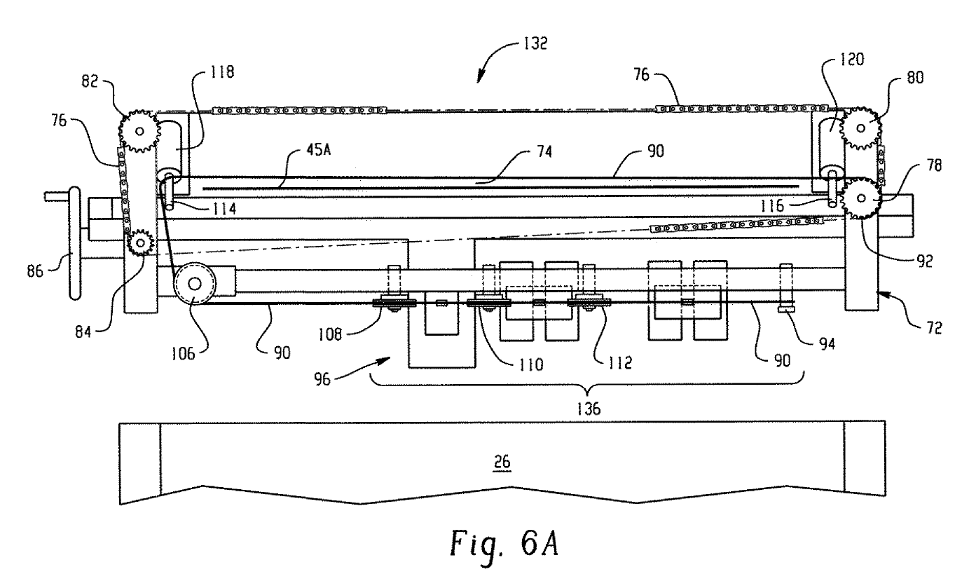

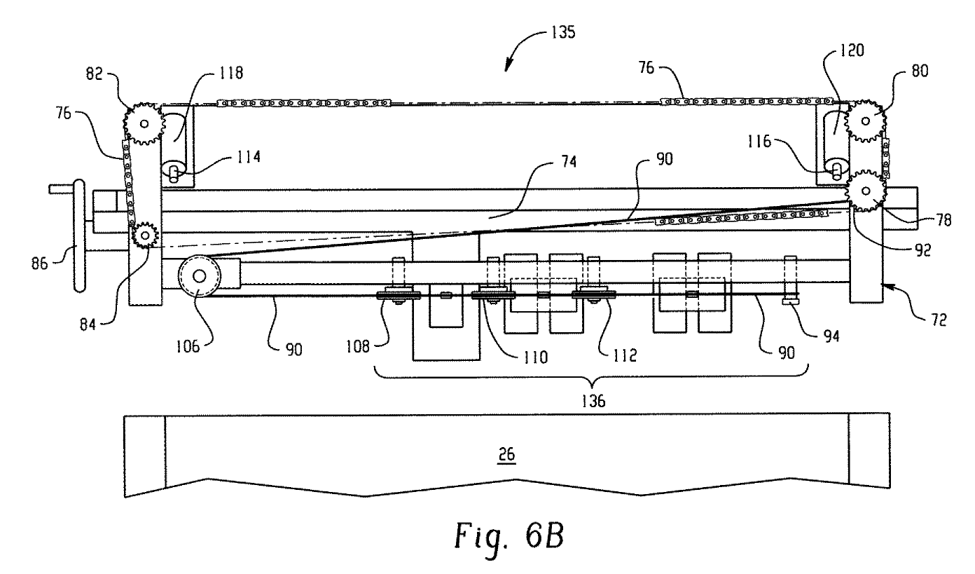

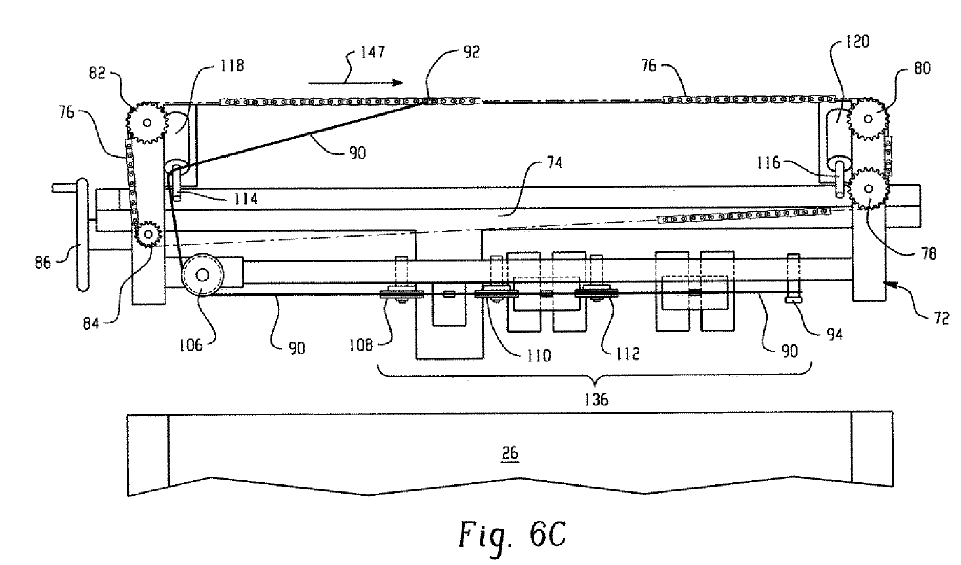

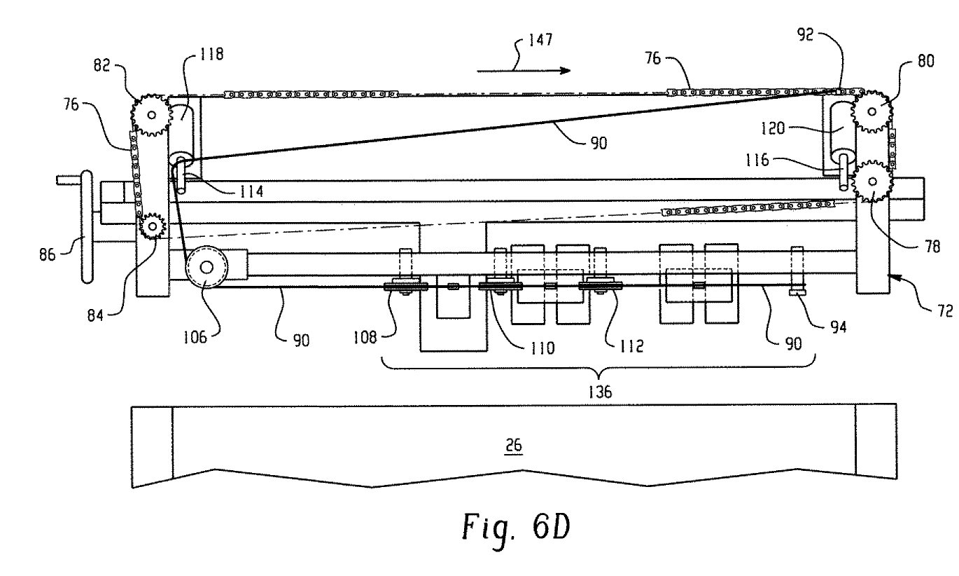

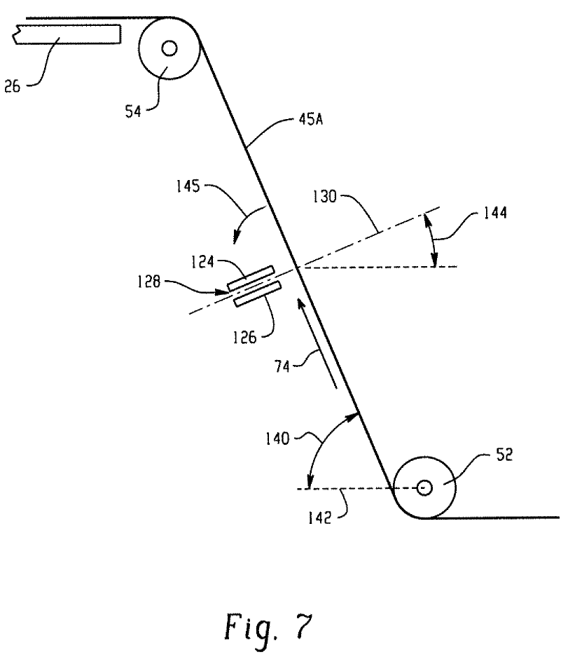

Referring to FIGS. 3, 4 and 5, as well as FIGS. 6A-6D and FIG. 7, there is shown cutter 28 which includes generally a support frame 72 defining a cover stock feed path 74 therethrough. A positioning loop in the form of an endless roller chain 76 encircles the cover stock feed path and is mounted on a plurality of sprockets 78, 80, 82 and 84. Sprocket 84 is a drive sprocket coupled to a hand crank 86 by way of a gear box 88, while the other sprockets are suitably idler sprockets. A chain lock 89 may be engaged to prevent motion of the chain during a cutting operation, as discussed further below.

A cutting cable 90 is attached to chain 76 by a double link at 92 and fastened to frame 72 at 94. Between 94 and link 92 a biasing and tensioning mechanism 96 includes a plurality of weights 98, 100 and 102 and pulleys 106, 108, 110 and 112. A releasable cable lock is provided in the form of a pair of upwardly-projecting members 114, 116 attached to pneumatic cylinders 118, 120 as shown in the various Figures. Members 114, 116 project upwardly through a pair of cable guide plates 115, 117 as shown, Chain lock 89 is likewise provided in order to prevent rotation of chain 76 during a cutting operation.

A pair of guide bars 124, 126 support a web of material as it is cut by cable 90. Bars 124, 126 may be angle-iron bars or of any other suitable construction defining therebetween a channel 128 which lies in a cutting plane 130 substantially perpendicular to cover stock feed path 74 and adjacent guide plates 115, 117.

When operating system 10, cutting cable 90 is disposed in a re-set position 132 (FIG. 6A) where it is poised to cut a web feeding along path 74. To this end, cable 90 is held out of the feed path by cable lock members 114, 116 despite being biased to a drawn position 135 by weights 98, 100, 102. When a new web is spliced to a depleted web, members 114, 116 are lowered by way of cylinders 118, 120 below guide plates 115, 117 such that the biasing and tensioning weights 98, 100 and 102 draw the cable through a web in the feed path along a cutting plane as is seen in FIGS. 6A to 6D and further illustrated schematically in FIG. 7.

In one embodiment, a method of continuously feeding cover stock to a wallboard manufacturing line comprises: (a) feeding a first web of cover stock from a first roll thereof upwardly to a splicing table along an upwardly-extending feed path; (b) feeding a second web of cover stock from a second roll thereof upwardly along the upwardly-extending feed path; (c) splicing the second web of cover stock to the first web of cover stock on the splicing table to form a spliced web; (d) severing the first web on the upwardly-extending feed path by transferring a cutting cable on one side of the feed path in a re-set position to another side of the feed path in a drawn position, the cutting cable being attached to a positioning loop and a biasing and tensioning mechanism, wherein the positioning loop is configured and adapted to rotatably deploy the cutting cable from the drawn position to the re-set position upon motion thereof around the cover stock feed path, and wherein the biasing and tensioning mechanism is adapted so as to be operable to (i) draw the cutting cable from the re-set position to the drawn position through the cover stock feed path thereby cutting cover stock disposed in the feed path; and (ii) maintain tension on the cutting cable as it is moved from the drawn position to the re-set position, thereby retracting any slack portions of the cable to a sequestered position away from the cover stock feed path; (e) feeding the spliced web forward to a wallboard-forming line; and (f) rotatably deploying the cutting cable around the spliced web from the drawn position to the re-set position In many cases the feed path extends upwardly at an angle of inclination of from about 60° to about 85°. In still other cases, the feed path extends upwardly at an angle of inclination of from about 70° to about 75°. In one embodiment, the cutting cable moves through a cutting plane between the re-set position and the drawn position which is substantially perpendicular to the upwardly-extending feed path. In one embodiment, severing the first web is carried out within about 1 second or less of completing splicing the second web to the first.

Referring to FIG. 6A, there is shown schematically cutter 28 with cutting cable 90 in the re-set or ready-to-cut position 132 with respect to web 45A wherein the cutting cable is held away from feed path 74 of web 45A in a position distal to the splicing table and ready to be spliced when roll 22 is depleted. In this position, chain lock 89 is engaged to prevent rotary motion of the loop during cutting.

When roll 22 is depleted, web 45B of roll 24 is spliced to 45A of roll 22 by action of splicing roll 58, whereupon pneumatic cylinders 118, 120 withdraw members 114, 116 below cable guide plates 115, 117 such that weights 98, 100 and 102 draw the cable across web 45A to cut it. The cable is drawn to “drawn” position 135 shown in FIG. 6B, passing through feed path 74 and channel 128 defined by guide bars 124, 126, thus severing the tail of web 45A which falls away since it extends upward as shown in FIG. 7.

FIG. 7 illustrates schematically web 45A traveling along feed path 74, extending upwardly at an angle of inclination 140 with respect to a horizontal 142 between rollers 52, 54 of system 10. Due to the angle and its inward or lower position with respect to web 45B, web 45A will fall away when severed in a direction indicated by arrow 145. Note that cutting plane 130 between bars 124, 126 is substantially perpendicular to feed path 74, having a complementary cutting angle 144.

In one embodiment, the splicing and cutting operations are coordinated by controller 60 which operates cylinders 118, 120 and pneumatically activated roller 58 of table 26 in a timed, nearly contemporaneous sequence of 1 second or less.

After web 45A is severed, spliced web 45B is fed in direction 46 for continuous feed of cover stock to the wallboard production line.

Cutting cable 90 is then re-deployed around the spliced web as shown in FIGS. 6C and 6D. In FIG. 6C, the cable has been partially re-deployed about path 74 and web 45B by way of chain 76 which is moved in direction 147 by way of hand crank 86, gearbox 88 and the sprockets upon which it is mounted. This motion is contained as shown in FIG. 6D where the cable is almost re-set and is further carried out until the cable is fully re-set around the running web as shown in FIG. 6A. The process is repeated as new rolls are brought on-line.

It is appreciated from FIGS. 6C and 6D that cutting cable 90 is kept away from feed path 74 when the cable is deployed from the drawn position to the re-set position by cable lock members 114, 116. Throughout operation, counterweights 98, 100 and 102 maintain tension on the cable and sequester any extra length at 136. In one embodiment, a dominant weight 98 at least 50% or 100% heavier than the other weights is used to reduce “bounce” in the system.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A cutter for wallboard cover stock comprising:
(a) a support frame having a cover stock feed path therethrough;
(b) a positioning loop around the cover stock feed path mounted on the support frame;
(c) a cutting cable attached to the positioning loop;
(d) a biasing and tensioning mechanism for biasing the cutting cable to a drawn position and maintaining tension on the cable,
wherein the positioning loop is configured and adapted to rotatably deploy the cutting cable from the drawn position on a first side of the cover stock feed path to a re-set position on a second side of the cover stock feed path upon motion thereof around the cover stock feed path, and
wherein the biasing and tensioning mechanism is adapted so as to be operable to (i) draw the cutting cable from the re-set position to the drawn position through the cover stock feed path thereby cutting cover stock disposed in the feed path; and (ii) maintain tension on the cutting cable as it is moved from the drawn position to the re-set position, thereby retracting any slack portions of the cable to a sequestered position away from the cover stock feed path; and
(e) a releasable cable lock for securing the cable in the re-set position and releasing the cable therefrom for transfer to the drawn position.

2. The cutter according to claim 1, wherein the positioning loop is an endless loop encircling the feed path and is coupled to a loop drive assembly for moving the endless loop around the cover stock feed path.

3. The cover stock supply system according to claim 1, wherein the cover stock feed path extends upwardly through the support frame of the cutter at an angle of inclination of from about 60° to 85°.

4. The cover stock supply system according to claim 1, wherein the cover stock feed path extends upwardly through the support frame of the cutter at an angle of inclination of from about 70° to 75°.

5. The cutter according to claim 4, wherein the loop drive assembly includes a lock for preventing motion of the loop during a cutting operation.

6. The cutter according to claim 1, wherein the cutting cable is attached to the support frame.

7. The cutter according to claim 1, wherein the biasing and tensioning mechanism comprises a plurality of counterweights.

8. The cutter according to claim 7, wherein the plurality of counterweights comprises a primary biasing weight at least 50% heavier than any other counterweights of the biasing and tensioning mechanism.

9. The cutter according to claim 1, wherein the releasable cable lock comprises at least one retractable member adapted to release the cable from the re-set position for transfer to the drawn position.

10. The cutter according to claim 9, wherein the retractable member is coupled to an actuating cylinder.

11. The cutter according to claim 1, wherein the cutting cable is mounted for motion along a cutting plane during transfer from the re-set position to the drawn position in a cutting operating and further comprising a pair of guide bars for guiding the cover stock along the feed path, the guide bars defining a channel in the cutting plane through which the cable moves during a cutting operation.

12. A cover stock supply system for continuously feeding cover stock to a wallboard production line comprising:
(a) a plurality of cover stock cradles for receiving rolls of cover stock;
(b) a splicing table;
(c) a cover stock cutter disposed between the cover stock cradles and the splicing table, the cover stock cutter including: (i) a support frame having a cover stock feed path therethrough; (ii) a positioning loop around the cover stock feed path mounted on the support frame; (iii) a cutting cable attached to the positioning loop; (iv) a biasing and tensioning mechanism for biasing the cutting cable to a drawn position and maintaining tension on the cable, wherein the positioning loop is configured and adapted to rotatably deploy the cutting cable from the drawn position on a first side of the cover stock feed path to a re-set position on a second side of the cover stock feed path upon motion thereof around the cover stock feed path, and wherein the biasing and tensioning mechanism is adapted so as to be operable to (A) draw the cutting cable from the re-set position to the drawn position through the cover stock feed path thereby cutting cover stock disposed in the feed path; and (B) maintain tension on the cutting cable as it is moved from the drawn position to the re-set position, thereby retracting any slack portions of the cable to a sequestered position away from the cover stock feed path; the cutter further including (v) a releasable cable lock for securing the cable in the re-set position and releasing the cable therefrom for transfer to the drawn position, and
(d) a plurality of rollers for providing cover stock from the cradles through the cutter, over the splicing table to a wallboard production line.

13. The cover stock supply system according to claim 12, wherein the cover stock feed path extends upwardly through the support frame of the cutter at an angle of inclination of from about 60° to 85°.

14. The cover stock supply system according to claim 12, wherein the cover stock feed path extends upwardly through the support frame of the cutter at an angle of inclination of from about 70° to 75°.

15. The cover stock supply system according to claim 12, wherein the cutting cable moves through a cutting plane between the re-set position and the drawn position which is substantially perpendicular to the feed path through the support frame of the cutter.

16. A method of continuously feeding cover stock to a wallboard manufacturing line comprising:
(a) feeding a first web of cover stock from a first roll thereof upwardly to a splicing table along an upwardly-extending feed path;
(b) feeding a second web of cover stock from a second roll thereof upwardly along the upwardly-extending feed path;
(c) splicing the second web of cover stock to the first web of cover stock on the splicing table to form a spliced web;
(d) severing the first web on the upwardly-extending feed path by transferring a cutting cable on one side of the feed path in a re-set position to another side of the feed path in a drawn position, the cutting cable being attached to a positioning loop and a biasing and tensioning mechanism,
wherein the positioning loop is configured and adapted to rotatably deploy the cutting cable from the drawn position to the re-set position upon motion thereof around the cover stock feed path, and
wherein the biasing and tensioning mechanism is adapted so as to be operable to (i) draw the cutting cable from the re-set position to the drawn position through the cover stock feed path thereby cutting cover stock disposed in the feed path; and (ii) maintain tension on the cutting cable as it is moved from the drawn position to the re-set position, thereby retracting any slack portions of the cable to a sequestered position away from the cover stock feed path;
(e) feeding the spliced web forward to a wallboard-forming line; and
(f) rotatably deploying the cutting cable around the spliced web from the drawn position to the re-set position.

17. The method according to claim 16, wherein the feed path extends upwardly at an angle of inclination of from about 60° to about 85°.

18. The method according to claim 16, wherein the feed path extends upwardly at an angle of inclination of from about 70° to about 75°.

19. The method according to claim 16, wherein the cutting cable moves through a cutting plane between the re-set position and the drawn position which is substantially perpendicular to the upwardly-extending feed path.

20. The method according to claim 16, wherein cover stock is selected from paper or glass mat.
